(19) United States
(12) Patent Application Publication
(10) Pub. No.: US 2024/0351222 A1
(43) Pub. Date: Oct. 24, 2024

(54) HIGH TEMPERATURE END EFFECTORS FOR ROBOTS

(71) Applicant: Virginia Commonwealth University, Richmond, VA (US)

(72) Inventors: Logan Schorr, Henrico, VA (US); Ravi Hadimani, Glen Allen, MD (US); Bradley Johnson, Richmond, VA (US)

(21) Appl. No.: 18/638,895

(22) Filed: Apr. 18, 2024

Related U.S. Application Data
(60) Provisional application No. 63/460,111, filed on Apr. 18, 2023.

(51) Int. Cl. B25J 15/08; B22F 10/28; B22F 12/88; B22F 12/90; B33Y 10/00; B33Y 30/00; B33Y 50/02; B33Y 70/00

(52) U.S. Cl. CPC B25J 15/08; B22F 12/88; B22F 12/90; B33Y 30/00; B33Y 50/02; B33Y 70/00; B22F 10/28; B33Y 10/00

(57) ABSTRACT

A robotic gripper is capable of withstanding the high temperatures of processes such as metal additive manufacturing. One or more of the fingers of the gripper include a casted ceramic insulator with a steel finger backing. Industrial thermocouples may attach to a finger for active temperature monitoring. An exemplary robotic gripper is adaptive, usable on a collaborative robot, and temperature resistant to over 1000° C. without introducing costly augmentations such as liquid cooling.

### CROSS-REFERENCE TO RELATED APPLICATIONS

This application claims the benefit of U.S. Provisional Patent App. No. 63/460,111, filed Apr. 18, 2023, the complete contents of which are herein incorporated by reference.

### STATEMENT OF GOVERNMENT INTEREST

This invention was made with government support under contract no. 2024561 awarded by the National Science Foundation. The government has certain rights in the invention.

### FIELD OF THE INVENTION

The invention generally relates to robotics and, more specifically, high temperature end effectors.

### BACKGROUND

There exists a distinct lack of adaptive, high-temperature resistant robotic end effectors for collaborative robots. More generally, there is a lack of extreme temperature adaptive grippers in robotics.

The specific need for high-temperature resistance as well as robotic grip adaptability is particularly notable in the field of automating post-processing metal additive manufacturing (AM). AM is a rapidly developing field, directed towards creating functional parts on a short turnaround. Laser bed powder fusion (LBPF) processes need to reach temperatures just below the melting temperature of the working material in order to bond the layers together, and many metals have melting points around or exceeding 1000° C. After these parts are fabricated, they need to be post-processed to remove unwanted artifacts from the fabrication process or to alter mechanical and thermal properties. These processes can include layer-line smoothing, heat treatment, or support removal. Currently, this processing is primarily facilitated manually by a human, which significantly reduces the time saved when compared to traditional subtractive manufacturing. This is a known flaw of the AM process.

LBPF parts can have significant stored thermal energy after initial fabrication or processes such as heat treatment. Typically, a significant wait time is required for the part to reach safe temperatures. Normal robotic grippers for collaborative robots have an upper operating range at around 40-50° C. The fingers of the gripper are made of a soft, rubber material to make pick-and-place operations easier with increased traction but are not suitable for high temperature handling. There exists a higher stage of resistance, with grippers that can withstand a temperature of up to 150° C. However, that temperature range is still far below what is needed to withstand the temperatures of LBPF parts. The highest temperature commercially available solution known to the inventors at the time of this disclosure is a Kevlar boot that encapsulates an entire gripper to provide temperature protection. Kevlar as a polymer starts to break down at temperatures well below 1000° C.—in some cases, the material can start breaking down as early as 400° C. While an upper operating temperature limit of 400° C. may be satisfactory for certain purposes, handling LBPF parts is not one of them.

An additional consideration for a gripper designed for AM post-processing is adaptability. Generally stated, an adaptive gripper is one that is able to grasp multiple shapes and sizes of objects. AM poses a unique constraint for robotic grippers in that subsequent printed parts may be different from prior printed parts, which makes having an adaptive end effector highly desirable.

Robotic grippers employed in forging and hot stamping operations are generally not suited for use with AM. For example, grippers employed in forging operations are generally too large to navigate around a build enclosure for an AM printer and too heavy to use with a collaborative robot which typically have very low payload limits.

Maximum operating temperatures for some robotic end effectors may be increased to a degree by incorporating active solutions such as cooling units. However, there is an inherit disadvantage to such active solutions due to needing a large thermal storage tank to decrease effects of thermal shock as well as needing fingers with internal channels. Such requirements make this solution both cost and space ineffective.

Many robotic grippers in existence today are custom tailored to specific types of parts, such as raw billets or car doors, and typically designed for long term processing of a very specific size and shape of object. A custom gripper customized to work with just one shape and size of object at the cost of 10K-20K USD can be economically justified in industries in which the batch size is several million parts over 1-2 years. However, for fields such as metal additive manufacturing, batch size can be as low as a single part, making highly customized single-part-specific robotic grippers cost prohibitive. Greater automation in this context therefore appears impossible. The industry lacks a single robot solution that can be used for any number of parts and is able to withstand handling of high temperature objects.

In summary of the above, traditional robotic grippers are generally either highly specialized to a specific shape of part or are unable to deal with high temperatures. To achieve greater automation in contexts such as post-processing metal additive manufacturing parts, a robotic gripper that is both adaptive and temperature resistant is needed.

### SUMMARY

According to an aspect of some embodiments, end effectors such as grippers are provided which are innately high temperature resistant. For example, some exemplary devices may operate at a temperature of at least 1000° C. and be capable of continuous holding times of at least 60 seconds for objects having such temperatures. The maximum operation temperature is innate/inherent to the end effector. No external fixtures or devices are required to be used in conjunction with the robotic end effector in order for the robotic end effector to be operable at the specified temperature.

Some embodiments are directed to an end effector such as a gripper that is both adaptive and high temperature resistant. According to an aspect of some embodiments, an exemplary end effector is usable for handling any number of differently sized parts without sacrificing high thermal resistance requirements.

According to an aspect of some embodiments, an exemplary robotic finger assembly comprises an alloy finger and an insulator, in particular a ceramic insulator. A ceramic interface with a metal backing allows for extreme thermal performance with minimal impact on robotic payload and no changes to operating stroke. In contrast grippers made entirely of metal, exemplary finger assemblies add ceramic insulators between the object to be gripped and the metal finger backing. The metal finger backing provides structural support through the length of the finger and is adapted to interface with a main body of a full end effector assembly (e.g., a wrist, palm, or like structure which coordinates the collective actions of multiple fingers). The ceramic insulator, on the other hand, provides direct thermal insulation between the object(s) to be gripped and the metal finger backing. The insulator serves to prevent heat transfer into the main body of the gripper and protect it. An exemplary device controls the heat that is allowed to enter the robotic system by means of the ceramic insulator. Heat cannot be conducted into the metal of the robot without having first past through the ceramic insulator. The ceramic insulator is a poor conductor of heat and thus provides excellent shielding of a remainder of the robot from extremely hot objects being handled by the end effector.

According to an aspect of some embodiments, the insulator is made from one or more castable ceramic materials. Employing ceramic mixtures which are castable offers the advantage of considerable customizability of the ceramic insulator. Using a castable ceramic enables structures such as but not limited to holes, counterbores, and surface texturing without requiring any machining of ceramic. Due to the many design possibilities, the satisfactory mechanical and thermal properties, and the ease of production, a casted ceramic is an exemplary material for insulators in many embodiments. An exemplary material for the insulator is, for example, castable aluminum-oxide ceramic composite.

Exemplary methods of producing end effectors allow for the creation of many different gripper designs, allowing for inexpensive customization beyond the gripper being adaptive. Insulators may be designed to better grip round shapes, or with certain geometric insets for specific parts, with an extreme temperature adaptive gripper.

An exemplary gripper may be produced to have a contact surface which is conformal to a particular predetermined shape. A ceramic insulator may be produced based on a known shape (and size) of one or more objects which the ceramic insulator may be involved in gripping in its eventual state of use. For instance, based on the determined need to grip a spherical object, a ceramic insulator may be produced which has a spherical surface, in particular a spherical surface with a radius of curvature which is based on (e.g., may substantially correspond with) the radius of curvature of the spherical object. A uniquely shaped object to be gripped may be matched to a ceramic insulator produced to have an object-facing surface which imitates the unique shape of the uniquely shaped object. A backside of the same ceramic insulator, on the other hand, may not vary from one customized conformal insulator to the next. Accordingly a variety of ceramic insulators with differently shaped, contoured, sized, etc. surfaces intended to face objects to be gripped may share a commonly configured backside so that all of the variety of ceramic insulators are compatible with a single alloy finger backing and readily swappable with one another on such alloy finger if desired.

One or more conformal/custom-sided insulators may be manufactured to share a particular set of features which make them mutually compatible with a particular finger mounting system. For instance, despite the possibility of having differently shaped outward faces, multiple ceramic insulators may all be cast using a matching pattern of negatives so that all of the resulting cast ceramic insulators have matching through holes and counterbores or the like with one another for the ability to mount to the same alloy finger.

An exemplary method of making a ceramic insulator for an end effector may include steps of preparing a mold based on a desired shape and size of the finished insulator. Special surface geometries (facets, shapes, planes, curves, etc.) may be incorporated into the bottom of the mold for controlling the configuration of the face of the ceramic insulator which will, in its eventual state of use, face in the direction of an object to be manipulated (e.g., handled, gripped, moved, rotated, etc.). The mold preparation may include the inclusion/placement of one or more negatives where features such as through-holes, counterbores, or other “negative” features are desired in the finished ceramic insulator. The mold having been prepared, castable ceramic material in its pre-set state is poured into the mold and then subjected to one or more curing stages. After one or more of the curing stages, the ceramic and negatives/mold are separated from one another. The timing of removing negatives may differ from the timing of removing the exterior mold. The resulting cast ceramic insulator may or may not be subjected to further processing after the casting is fully completed. In many embodiments, however, no machining of the cast ceramic material should be necessary or indeed desired since all significant features and shapes of the ceramic insulator are created as part of the casting process. Molds and negatives may be made according to various techniques, e.g., by 3D printing, extrusion, molding, or machining of materials such as metal (e.g., steel) or polymers/plastic.

Some embodiments include an integrated temperature measurement system, allowing for improved safety as well as the ability to monitor object and device temperatures during processes such as heat treatment or subtractive processing. According to an aspect of some embodiments, one or more thermocouples are incorporated or incorporatable in a gripper to measure the temperature of a workpiece/object which is about to be handled or which is actively being handled. The gripper's robotic controller may be configured to not lift a workpiece if a sensed temperature of the workpiece exceeds a preset operating temperature limit.

According to an aspect of some embodiments, a ceramic insulator is assembled with a metal backing using fasteners which minimize the risk of damage to the ceramic and which allow for easy swapping of substitute or replacement insulators. For example, in an exemplary finger assembly, shoulder bolts (also sometimes referred to as shoulder screws) are used to mount the insulator to the metal finger backing so that it is not possible to overtighten and fracture the insulator. The holes are counterbored such that bolt heads do not interfere with the grasp and are unable to come into direct contact with the object to be grasped. As such there advantageously remains no heat conductive metal pathway from the object to be gripped into the robot. Insulators have multiple (e.g., four) holes for mounting the insulator using the shoulder bolts. An additional hole may be included, e.g., in the middle of the ceramic block, for a thermocouple.

According to some embodiments, exemplary devices are configured to withstand high operating temperatures without reliance on external fixtures or devices to handle high heat environments. For example, some robotic setups may dispense with or avoid supplementary devices such as blast shields or active cooling kits which, besides representing further tool costs, have the significant drawback of reducing robot payloads. Collaborative robots such as the UR5 by Universal Robots® often have fairly low maximum payloads, e.g., 5 kg in the case of the UR5. Exemplary end effectors and subassemblies of this disclosure have the advantage of minimizing the weight of the end effector itself without making sacrifices on thermal performance.

According to some embodiments, exemplary end effectors are configured for use with/by collaborative robots. Collaborative robots are attractive for many different reasons, such as but not limited to: a low-cost barrier to entry; relatively little safety needs in terms of light curtains, safety cages, or similar devices; and the ease of programming and implementation. Collaborative robots are suited to automating small-batch processes for a relatively affordable cost. According to some embodiments, exemplary finger assemblies may be configured as extensions of existing robots and existing adaptive grippers. For example, one or more exemplary finger assemblies may be configured for use with the body of a Robotiq 2F-140 gripper. Exemplary finger assemblies may have connection adapters allowing for connection to any number of gripper products.

According to an aspect of some embodiments, a high-temperature gripper enables capabilities of metal additive manufacturing (AM) as well as the safe handling of high-temperature objects in other use contexts. One of the advantages of some embodiments is realized in the context of utilizing automation in metal additive manufacturing such as laser bed powder fusion (LBPF). Some embodiments make possible the ability to remove metal additive manufacturing parts from the printer during the printing process (which is to say, part way through before all metal additive printing is finished) for the purpose of additional processing and then to place the part back into the printer to finish the metal additive printing process. The additional processing that may be performed in between stages of metal additive printing may include but is not limited to heat treating, grinding, drilling, and/or some other procedure. In some conventional situations such types of processing may be limited to postprocessing, whereas with exemplary grippers according to this disclosure, they may instead be performed at an earlier stage of production. Being able to accurately remove parts from a 3D printer and perform operations before the print job is finished allows for the manufacture of parts with more complex mechanical and thermal properties via in-process heat treatment. In addition, options for design complexity are more extensive by the enablement of previously impossible internal design features.

The ability to accurately move and replace an object inside of a 3D printer while processing allows for more complexity to parts made of metals, a medium that otherwise may limit options for part complexity. In 3D printers, the orientation at which an object is printed is very important and limits the success of features depending on this orientation. Exemplary grippers according to this disclosure may be configured to remove and replace objects in 3D printers in different orientations while withstanding the high temperatures of the metal objects being printed. Being able to remove and replace an object enables various features to be printed regardless of the starting orientation, due to the orientation being changeable mid-print. The ability to robotically manipulate a metal part being printed by an AM process also enables processing that would otherwise not be possible in the middle of a print, including but not limited to grinding, deburring, heat treating, and drilling. High temperature, highly adaptable grippers introduce the ability to have more robotic input in manufacturing processes, as they can handle things that humans otherwise could not. Whereas a human might have to wait for something to cool down, an exemplary robot is able to quickly and accurately pick it up immediately with little concern for the temperature. Being able to replace certain human activities effectively, cut down on processing time, and bolster manufacturing capabilities are some advantages realized by embodiments of this disclosure.

Advantages of exemplary embodiments include affordable robotic end effectors and subassemblies which are relatively easily produced and which provide unmatched thermal performance. The implementation of exemplary devices allows for a lower barrier to entry to additive and small batch manufacturing of metal parts for many industries. A single exemplary high performance adaptive gripper can service a vast range of parts, with ease of repair and replacement, making it extremely accessible.

### BRIEF DESCRIPTION OF THE DRAWINGS

FIG. 1A is a perspective view of an exemplary high temperature finger assembly.

FIG. 1B is another perspective view of the finger assembly.

FIG. 1C is a cross-sectional view of the finger assembly.

FIG. 1D is another cross-sectional view of the finger assembly.

FIG. 1E is a planar view of the finger assembly and shows the placement of the cross-sections for FIGS. 1C and 1D.

FIG. 1F is a finger assembly with a differently faced ceramic insulator from the assembly depicted in FIG. 1A.

FIG. 2A is an exemplary high temperature end effector that includes a gripper body and a pair of opposing high temperature finger assemblies.

FIG. 2B is an exemplary robotic setup including a robot with a multi-axis robotic arm on the end of which is mounted the exemplary end effector of FIG. 2A.

FIG. 2C is a block diagram of an exemplary robotic device or system with temperature feedback and decision making based on temperature readings from the end effector.

FIG. 3A is an isometric view of a thermal simulation setup.

FIG. 3B shows side and front profiles of the insulator used in the thermal simulation.

FIG. 4 is a graph of thermal analysis results showing the temperatures on both the sides of a simulated ceramic insulator of varying widths after 60 seconds.

FIG. 5 is an example mold with shoulder bolt pins in corners and thermocouple pin in center for casting a ceramic insulator.

FIG. 6A is compressive stress-strain curves for three partially heat-treated ceramic test samples.

FIG. 6B is compressive stress-strain curves for three fully heat-treated ceramic test samples.

FIG. 7A is 3-Point bending stress-strain curves for three partially heat-treated ceramic test samples.

FIG. 7B is 3-Point bending stress-strain curves for three fully heat-treated ceramic test samples.

FIG. 8A shows thermocouple mounting locations for a thermal conductivity test setup.

FIG. 8B is a diagram of the thermal conductivity test setup.

FIG. 9A is a CT scan image of a partially heat-treated ceramic test sample.

FIG. 9B is a CT scan image of a fully heat-treated ceramic test sample.

FIG. 9C is a CT scan image of a fully heat-treated ceramic test sample that additionally underwent a high temperature furnace test.

FIG. 10A is a render from the CT scan corresponding with FIG. 9A.

FIG. 10B is a render from the CT scan corresponding with FIG. 9B.

FIG. 10C is a render from the CT scan corresponding with FIG. 9C.

### DETAILED DESCRIPTION

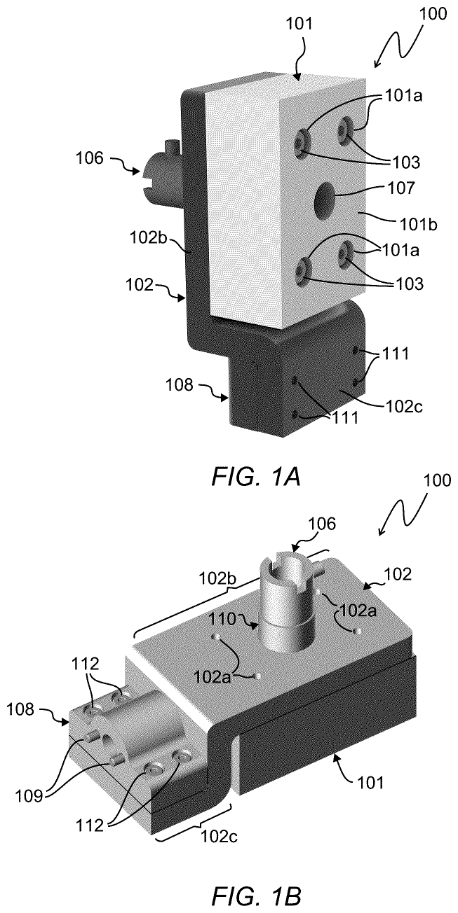

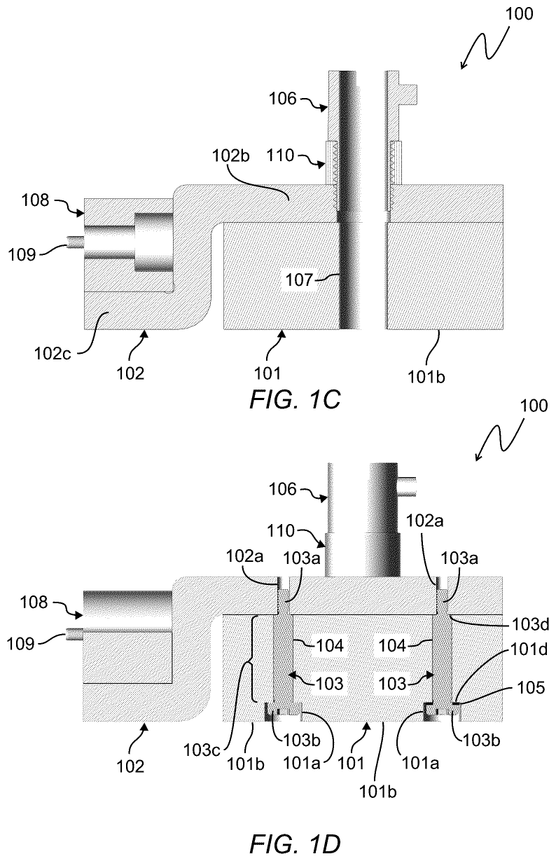

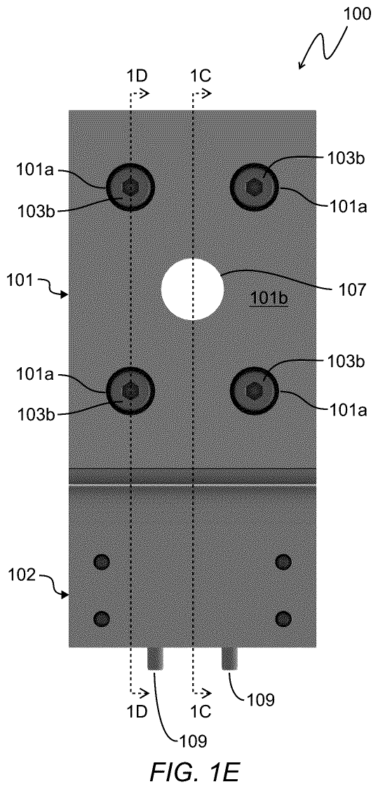

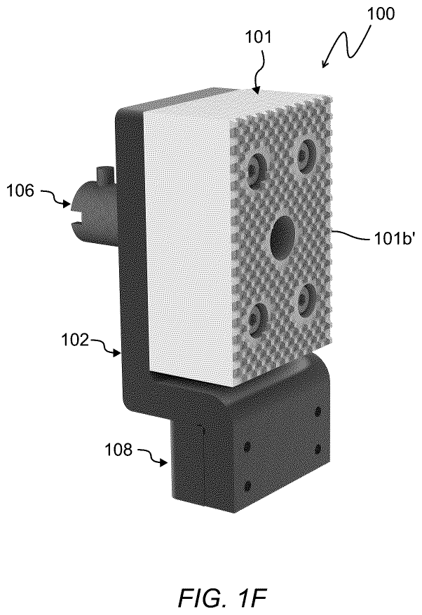

FIGS. 1A-1E are alternative views of an exemplary robotic end effector, or more precisely, an assembly for a robotic end effector which may be combined with similar or identical assemblies to make a robotic gripper. The assembly 100 may be characterized as a single digit, member, or finger of a robotic end effector. The assembly 100 on its own may be used for contacting an object, e.g., to push or press an object. In general, two or more assemblies 100 (or else an assembly 100 in combination with one or more other types of robotic finger) are used together to achieve functionality such as gripping of an object by the robotic end effector.

The exemplary assembly 100 comprises a ceramic insulator 101 and an alloy finger 102 backing the ceramic insulator 101. The assembly 100 is configured for use in high temperature operating conditions. For instance, the assembly 100 may have a maximum operation temperature of at least 400° C., or at least 500° C., or at least 800° C., or at least 1000° C., or at least 1500° C., or at least 2000° C., or at least 3000° C., or higher still. A central role of the insulator 101 is to minimize heat transfer to a body of a gripper and thereby protect it. The minimum thickness of the insulator 101 measured between the object contact surface 101b and the opposing side (which adjoins the backing 102b) may be predetermined partly based on the desired thermal drop between these opposite sides of the insulator. Depending on the embodiment, the insulator 101 may have a minimum thickness of, for example, 5 mm, 7 mm, 12 mm, 17 mm, 22 mm, 27 mm,

or some other thickness. The insulator 101 decreases the temperature experienced by the alloy finger 102. The alloy finger 102 comprises an offset such that the alloy includes a general L-shape or S-shape, for example. The size of offset in the alloy finger 102 may be selected based on the insulator 101 thickness. For instance, the offset size may be selected to substantially match the (maximum) insulator thickness size.

The ceramic insulator 101 is connected to the alloy finger 102 in such a way that the ceramic insulator 101 may be easily replaced or swapped out while the alloy finger 102 remains. A first ceramic insulator with a first shape is swappable with a second ceramic insulator with a second shape that is different from the first shape (without any other changes to the finger assembly, end effector, or robot). The shapes may include but are not limited to various sizes and types of prisms such as rectangular prisms. As especially clear from the cross-sectional view of FIG. 1D, the ceramic insulator comprises through holes 104 sized to respectively accommodate fasteners 103. Each fastener 103 is configured to have a first end 103a that is anchorable in the alloy finger 102. The opposite end 103b of fastener 103 is configured with respect to the hole 104 in the ceramic insulator 101 such that the ceramic insulator 101 is incapable of slipping off the fastener 103. Relatedly, it is not possible for the end 103b of fastener 103 to pass all the way through the hole 104. With the fastener anchored to the alloy finger 102, the ceramic insulator 101 is effectively trapped between the alloy finger 102 and the opposite end 103b of the fastener. As FIG. 1D shows, an exemplary fastener 103 may be configured so that end 103b has a minimum displacement distance from the alloy finger 102. In the illustrated example, a center portion 103c of the fastener 103 has a predetermined diameter which is larger than a fastener receiving hole 102a of the alloy finger 102. When the center portion 103c comes into contact with the alloy finger 102, the size difference prevents the fastener 103 from advancing further into the alloy finger 102. Such arrangement is advantageous in that it prevents accidental overtightening of fasteners 103 which can result in over constraining and possibly cracking the ceramic insulator 101. An exemplary type of fastener for achieving these benefits is a shoulder bolt. The ceramic insulator 101 may include recesses 101a such as countersinks or counterbores on a side opposite the alloy finger backing 102b. Such recesses 101a permit ends 103b of the fasteners to sit below the surface 101b of the ceramic insulator 101.

The surface 101b may be configured as an external object interface, which is to say, the surface 101b is configured for contacting an object to be acted upon by the end effector (e.g., surface 101b is the grip surface that contacts an object being gripped by the end effector in a state of use). An exemplary surface 101b may have a substantially flat surface contour or some other contour. For example, as an alternative to a flat planar surface, the contact surface 101b may be a curved surface or be a combination of flat and curved surfaces. A curved contour may be selected based on the shape of the objects intended to be gripped and/or to reduce the stress concentrations at the counterbores 101a.

In addition to surface 101b being configurable with any of a variety of different surface contours, the surface 101b may be configured with any of a variety of surface features/facets. As a non-limiting example, FIG. 1F shows ceramic insulator 101 having a surface 101b′ configured with a textured face. Surface features may include but are not limited to ridges (a ridged pattern), ribs (a ribbed pattern), studs (a studded patterns), and waves (a waves pattern).

The recesses 101a allow the fasteners 103 to not project past the surface 101b of the ceramic with the result that the fasteners 103 are not at risk of making contact with the object on which the end effector is acting. The fasteners 103 may be made of, for example, an alloy such as a steel alloy, and thus are inherently more thermally conductive than the ceramic insulator 101. It is therefore undesirable for the fasteners 103 to make any direct contact with objects being handled which may be of especially high temperature.

The ceramic material of insulator 101 may be expected to expand and contract with thermal variations, as may the alloy finger 102 and/or the fasteners 103. The assembly 100 may include one or more features to assist in accommodating fluctuations in dimensions within the assembly and thereby minimize the risk of the assembly loosening or wearing excessively over time. As one non-limiting example, a compressible spacer 105 of heat resistant material may be included in assembly 100 such as between end 103b and the retention surface 101d of the recess 101a. In addition, or in the alternative, a high temperature spacer may be situated between opposing faces of ceramic insulator 101 and alloy finger 102, and/or between alloy finger 102 and a shoulder surface 103d of fastener 103. The spacer in any of these arrangements may be configured as a thin film, gasket, washer, or similar component. The material of the compressible spacer may vary depending on its placement and the maximum temperature expected at such placement within the assembly. High temperature silicone is one option for placements where the local temperature to which the silicone is exposed is not expected to exceed 200° C., 300° C., or 350° C. for example. Other example spacer materials able to withstand higher temperatures than silicone are ceramic fiber materials such as a ceramic felt and basalt-based materials like basalt mat. Exemplary spacer material is suited to reversibly change dimensions (e.g., be squeezed) during periods of temporary dimensional changes of neighboring elements.

In the assembly 100 appearing in FIGS. 1A-1E, there are four fasteners 103, each situated in a respective (through) hole 104 of the ceramic insulator 101. Correspondingly, there is a respective fastener receiving hole 102a in the alloy finger 102 for each fastener 103. The receiving holes 102a are through-holes in the illustrated embodiment but may be blind holes in the alternative. From a manufacturing standpoint, through-holes are generally faster and less expensive to create than blind holes, particularly if the hole is subsequently threaded as is the case in the illustrated embodiment. Fasteners 103 may take different forms in different embodiments, but an exemplary fastener is a threaded fastener which secures to the alloy finger 102 in the receiving holes 102a via correspondingly sized threads in the receiving holes. In general, having at least three fasteners 103 arranged such that all three do not line in a single geometric line is advantageous for minimizing or preventing movement (e.g., rotation) of the ceramic insulator 101 relative to the alloy finger 102 backing the ceramic insulator in the fully assembled arrangement.

The section 102b of the alloy finger 102 which literally is at the back of the ceramic insulator 101 may be advantageously offset relative to a remainder 102c of the alloy finger 102. It is this remainder 102c of the alloy finger which may be configured with means for connecting the alloy finger 102 with further elements of an end effector or robot.

The alloy finger backing 102b may be offset from the remainder 102c where the adapter 108 attaches in order to accommodate for any thickness of insulator 101. The alloy finger's offset is such that the insulator 101 is able to remain flush with the edge of the gripper so as not to reduce the stroke of the end effector. By having the contact surface 101b be flush or setback with respect to other gripper surfaces, the gripper stroke is unchanged. If desirable, however, the contact surface 101b may project beyond any other surfaces of the gripper. The offset in the alloy finger allows for setting the surface 101b at a desired position relative other components of the finger assembly independent of the choice of ceramic insulator thickness. A gap between a side face of the insulator 101 and the alloy finger 102 may be included to reduce the surface area of contact between the alloy and ceramic.

The assembly 100 further includes a mount 106 for a temperature measurement system or device such as a thermocouple (e.g., a K-type chromel-alumel industrial thermocouple). As visible in FIG. 1C, the ceramic insulator 101 has a through hole 107 configured to accommodate the temperature measurement device. The temperature measurement device is insertable through the assembly 100 from the backside, which is to say opposite the gripping surface 101b. The sensing end of the temperature device is positionable at the same geometric surface (e.g., geometric plane) as surface 101b such that the temperature probe is able to contact an object being contacted (e.g., gripped) by surface 101b. The temperature measurement device such as a thermocouple may be attached using a bayonet style mount on the back of the alloy finger 102 to keep the thermocouple in place. The mount 106 may be configured to permit adjustments to the temperature measurement device displacement within the hole 107 such that the tip of the temperature measurement device can be made flush with the surface 101b of the insulator 101 when depressed (e.g., when grasping an object). The mount 106 may include or be accompanied by, for example, a spacer 110 (e.g., threaded spacer) for thermocouple positioning. A threaded spacer offers fine adjustment in displacement. The spacer 110 may be made of a metal such as aluminum (if operating temperatures are below the melting point of aluminum at this position on the finger assembly), or an alloy such as a steel alloy for higher operating temperatures. The assembly may further include a metal sleeve around the thermocouple to protect it from the high temperatures and act as a spring and allows the tip of the thermocouple to compress.

Additionally or alternatively to a contact temperature measurement device like a thermocouple, embodiments may include a temperature measurement device to test the temperature of a part without touching it. Exemplary non-contact temperature measurement devices include, for example, an infrared (IR) sensor or extended thermocouple.

The assembly 100 further includes an adapter 108 configured to connect the alloy finger 102 with further components of an end effector (e.g., a body of an end effector) or robot such as a robotic arm. The adapter 108 may be configured to allow various alignments of the end effector. Different adapters 108 may be provided which are all compatible with an alloy finger 102 but respectively configured to pair the alloy finger 102 with different robots. The adapter 108 is configured to interface between the alloy finger 102, in particular the end section 102c, and, e.g., a main body of an end effector. One or more alignment pins 109 may be included to help ensure that everything is mounted precisely. An exemplary adapter 108 may be made of, for example, an alloy such as but not limited to steel alloy. The alloy finger 102 may include threaded holes 111 configured to receive mounting screws 112 to attach the adapter 108 to the alloy finger 102.

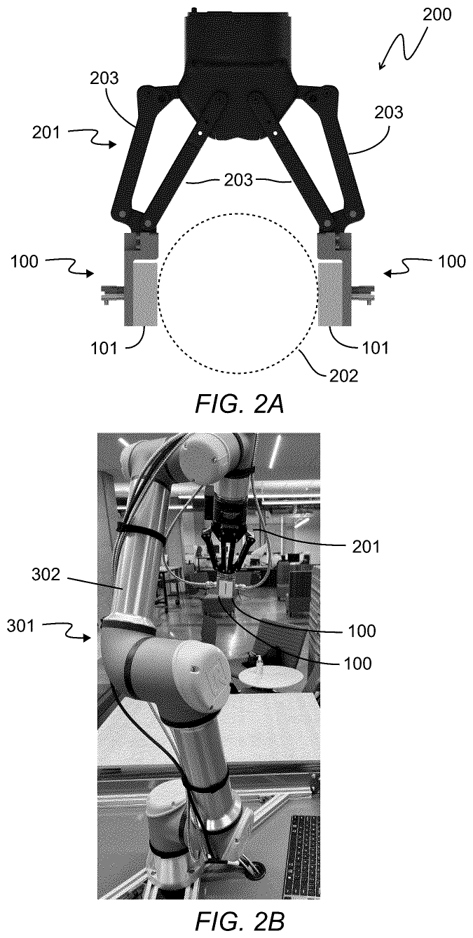

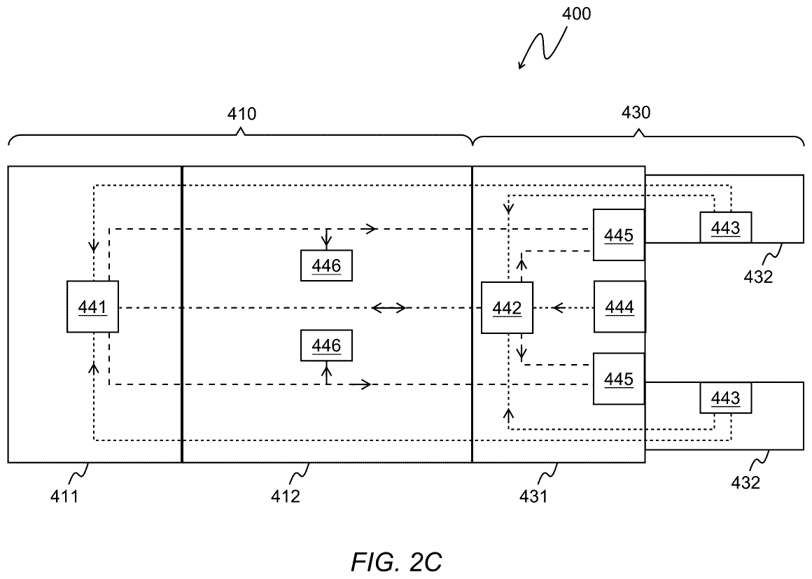

FIG. 2A shows a gripper 200 which includes two or more finger assemblies 100 attached to an exemplary gripper body 201. In this non-limiting illustrative example, the gripper 200 is a parallel gripper. The ceramic insulators 101 are in direct contact with an object 202 being gripped. The gripper body 201 may be a custom gripper body or any of a variety of commercially available gripper bodies which may include, for example, various jointed links 203 the movement of which is generally controlled by one or more motors in the gripper itself or else in the robot (e.g., robotic arm) to which the gripper is connected. For example, finger assemblies 100 may be combined with a Robotiq 2F-140 parallel gripper. As is generally known in robotics, robotic motors may generally include, for example, stepper motors or servo motors.

Some exemplary end effectors and grippers may be characterized as adaptive. Generally, adaptive may be defined as capable of a variable size gripping stroke. Adaptive may describe the nature of an end effector that is able to adjust to hold multiple shapes and sizes of parts.

Exemplary finger assemblies are attached to the body of an end effector, and the end effector is controlled by a robot. For example, FIG. 2B shows the gripper 200 including finger assemblies 100 connected with a complete robot 301 including a multi-axis robotic arm 302. Robot 301 is but one example of a variety of robot types which may be used in embodiments or to which exemplary finger assemblies may be adapted to connect for use as end effectors. Exemplary robots include, for example, collaborative robots such as the Universal Robots UR5e. Collaborative robots such as the Universal Robots UR5e are designed to be as ubiquitous as possible to increase utilization across a wide spread of industries. Exemplary finger assemblies 100 offer thermally insulated end effectors to a class of robots for which the existing industry lacks adequate high temperature solutions. FIG. 2B includes depiction of mounted thermocouples. The thermocouples are connected to the IO panel of the robot controller via signal converters.

FIG. 2C is a block diagram of a robotic device or system 400 with exemplary feedback and decision making which may be included in some embodiments. An exemplary robotic device or system 400 measures one or more temperatures at the gripper 430 using one or more temperature measurement devices 443/444 such as thermocouples or infrared (IR) sensors. One or more processors/controllers 441/442 (including but not limited to CPUs, microprocessors, or the like) receive the temperature readings and make one or more determinations based on the sensed temperature(s). One or more actions of the robot are decided or changed based on the sensed temperatures. In general, decision output from the controllers 441 or 442 may change the actuation of motors 446 affecting robotic arm(s) 412 or motors 445 of end effector 430 which includes a body 431 and fingers 432. As one non-limiting example, the gripper 430 may itself include a robotic controller 442, and the controller 442 may be configured to not lift a workpiece if a sensed temperature of the workpiece exceeds a preset operating temperature limit. As another example, one or more activities may be started, delayed, ended, or adjusted in one or more respects based on the sensed temperature. For example, a part being handled by the robotic system 400 may require heat treatment, and the heat treatment may require the part reaching a predetermined temperature. The temperature of the part may be monitored cyclically or continuously by the temperature measurement device 443 and the decision and timing of continuing or ending heat treatment, and/or of adjusting the output of the heat source, and/or of adjusting the position of the handled part relative the heat source, may be made or adjusted based on one or more of the temperature readings. In the context of an additive manufacturing process to produce a metal part, one or more of controllers 441/442 may begin, end, adjust, continue, etc. any of a number of stages or parameters of production based on the temperature feedback. For example, if the AM printed part (be it partially printed or fully printed) requires post-processing/secondary activities, the timing of moving the part by the gripper 430 from the AM printer or into a platform for such other processing or activities may be made based on the temperature feedback. For instance, the gripper 430 may read the temperature of the AM printed object (e.g., by gripper 430 gripping the object with finger assemblies 432 and so bringing thermocouples 443 into contact with the object and/or by contactless infrared reading from contactless sensor 444) and wait to move it from the AM printer until the sensed temperature falls below a predetermined threshold.

The arrangement of one or more processors/controllers for performing decisions and determinations for a robotic system such as those described in the preceding paragraph may differ among embodiments. As illustrative examples, FIG. 2C depicts a controller 441 in a body/base 411 of robot 410. For purposes of this illustration robot 410 substantially includes all parts of the robotic system 400 except the end effector 430. The controller 441 controls one or more of the moving parts of the robot such as motors 446 in the arm 412 and/or motors 445 of the end effector. In addition or in the alternative to a controller processing temperature data in a main part of a robot, an exemplary robotic system may have a controller 442 specifically as part of the end effector/gripper 430. In the case of multiple controllers, decisions made by controllers 441 and 442 may be made to some extent independently of decisions of one another. They also may be coordinated as implied by the data connection illustration in FIG. 2C.

An exemplary alloy finger 102 may be made out of an alloy steel such as but not limited to 4140 alloy steel. The alloy finger 102 is configured in material and dimensionally to be adequately strong to withstand relatively high holding forces without deflection and heat resistant to properly support the ceramic insulator 101 even during long hold times. The alloy finger 102 may be a hardened alloy. The alloy material choice is resistant to both the gripping force and the elevated temperatures experienced during long hold times.

An exemplary insulator 101 is made of a ceramic such as but not limited to an aluminum oxide ceramic. Other materials which may be employed in various embodiments may include but are not limited to: alumina, zirconia, silicon nitride, silicon carbide, and other ceramics. The insulator 101 may be monolithic. Ceramic has a very low thermal coefficient (low thermal conductivity) and high compressive strength. An exemplary castable ceramic is capable of handling extremely high temperatures, e.g. upwards of 2000° C. (i.e., at least 2000° C. or more) depending on the composition. Because ceramic composites are difficult to machine, exemplary embodiments may further employ ceramics which are castable. Castable ceramics advantageously avoid the high costs and significant tooling required for machining ceramics. Castable ceramic is much cheaper and allows a wide breadth of design complexity without requiring expensive machining techniques.

For any embodiment, the particular ceramic or ceramics selected for the insulator may be selected based on considerations such as compression strength, the modulus of rupture, and the thermal conductivity. The properties of a cast ceramic piece can vary significantly based on the casting parameters. Exemplary casting processes may include, for example, casting under a vacuum or vibrating the mold.

A non-limiting exemplary process for manufacturing castable ceramic insulators may include one or more of the following features. The insulators may be cast using a mold which can be made to any desired shape to accommodate special geometric needs for the gripper. The mold may be produced by, for example, 3D printing. Following are two distinct exemplary methods used for casting the ceramic. A first example method for casting the ceramic uses a fully printed form mold for the insulator, printed out of, e.g., acrylonitrile styrene acrylate (ASA). The internal geometry is captured using the plastic impression. The ceramic's first stage is a multi-hour cure, e.g., 24 hr room temperature cure. Following this cure, as much of the ASA is removed as possible using, e.g., acetone, as ASA is soluble in acetone. Then the ceramic is placed into a furnace for a multi-hour post-cure, e.g., a furnace set at 1000° C. for overnight post-cure. The remaining ASA is burned off during this process, leaving perfectly formed interfaces. A second example method of casting ceramic is operationally identical to the first, with the exception that the internal geometry is created using machining shafts (e.g., of aluminum) rather than relying on the mold. The aluminum pins are removed after the room temperature cure, to reduce any effects from the burn-off of the ASA in the post cure.

Metal components of exemplary embodiments (e.g., alloy finger, adapter, etc.) may be made by, e.g., subtractive milling by a milling machine. Metal components may alternatively be made by casting, for example.

Applicable fields of use for exemplary embodiments include but are not limited to: high temperature end effectors, high temperature automation, high temperature robots, and high temperature adaptive grippers. Exemplary embodiments enable further automation in high temperature processes, including metal additive manufacturing, casting, and forging. These processes have traditionally required the same part to be manufactured over and over again to reap the benefits of automation, as the process is typically not adaptive. An exemplary adaptive gripper according to embodiments herein are capable of handling many shapes and sizes of objects, while also being able to withstand the high temperatures. Exemplary embodiments allow material handling and processing at high temperatures. Exemplary grippers may be used in the efforts of automating post processing metal additive manufacturing (AM) parts, utilizing incorporated industrial thermocouples to ensure safe usage. With exemplary insulated finger assemblies for the end effectors, the ability to take parts in and out of the metal AM machine without losing any accuracy can be fully realized.

Exemplary assemblies may be configured to withstand continuous contact (e.g., while gripping) with extremely hot objects for a duration of time of at least 10 s, 30 s, 60 s, or more. Objects made by an additive manufacturing process such as laser bed powder fusion (LBPF), including but not limited to selective laser melting (SLM) or direct metal laser sintering (DMLS), may be made of any of a wide variety of metals and alloys. Some examples, and corresponding example temperatures which the objects may reach according to the material melting point, are as follows: titanium alloys (1660° C.), stainless steel alloys (1400° C.), aluminum alloys (570° C.), tool steels (1400° C.), nickel-based alloys (1260° C.), cobalt chrome alloys (1320° C.), gold (1064° C.), silver (961° C.), platinum (1772° C.), and copper/copper alloys (1085° C.). Exemplary end effectors and finger assemblies for the same may correspondingly be configured to withstand contact with objects having or exceeding any one or more of these example temperature thresholds without damage to the end effector or other parts of the robot.

### Examples

A three-part finger assembly consistent with FIGS. 1A-1E was created to attach to a Robotiq 2F-140 parallel gripper. The alloy finger and adapter were made out of alloy steel. The insulator was made from castable aluminum-oxide ceramic composite. Due to the material selected, a cast ceramic, it was important to test the properties provided by the raw material manufacturer as the properties can vary significantly based on the casting parameters. The three properties that were provided and tested were the compression strength, the modulus of rupture, and the thermal conductivity. For each of these tests, the goal was to produce results close to the manufacturer specification to examine the effectiveness of the casting method. The gripper finger assembly's optimal dimensions were first determined by thermal simulations that were then experimentally validated.

This design introduces a solution that enables collaborative robots to assist in automating post processing of additive manufacturing (AM). The cast ceramic insulator was tested, both in simulations and in experiments, to quantify the material properties as well as to determine if the insulator proved effective at the function of insulating the metallic finger backing. Under the casting conditions used in the creation of the test samples, it was determined that the ceramic had a compressive strength of 45.57 MPa and a modulus of rupture of 20.50 MPa, both of which either fall within or exceed expected values. The experimental thermal conductivity was 5.123 W/mK, higher than the manufacturer specification but still low enough to be an effective insulator. The thermal simulations (detailed below) show that the gripper is capable of handling objects upwards of 1000° C. safely, without causing damage to the gripper. Based on the thermal shock test and the resulting CT scan, it can be concluded that thermal stress propagates on pores from inaccuracies in the casting process, and the insulator will last for at least one cycle, and very likely more. The flexibility of the casting process allows for different casted dies to be used to accommodate specific geometry, although all experimentation considered only rectangular prism shaped insulators.

Thermal and static structural simulations were performed to verify the validity of the design. Maximum normal operating conditions were selected to be a 1000° C. steel cube in full contact with the insulator over a 60 second period, with 125 N of gripping force. With these conditions, the maximum temperature experienced by the steel finger was only 58.3° C., illustrating the virtue of the insulator. The minimum factor of safety (FOS) for the finger was 8.51, and for the ceramic interface, the minimum FOS was 2.10. The insulators have been mechanically tested for thermal shock failures up to 370° C. and simulated to a maximum temperature of 3000° C., with 240 seconds of contact. The FOS of the insulator at these conditions was approximately 1.6. The gripper assembly has seen demonstrational use with a 2 kg payload using a grip force of 125 N for roughly 6 hours with zero degradation.

### Thermal Simulations

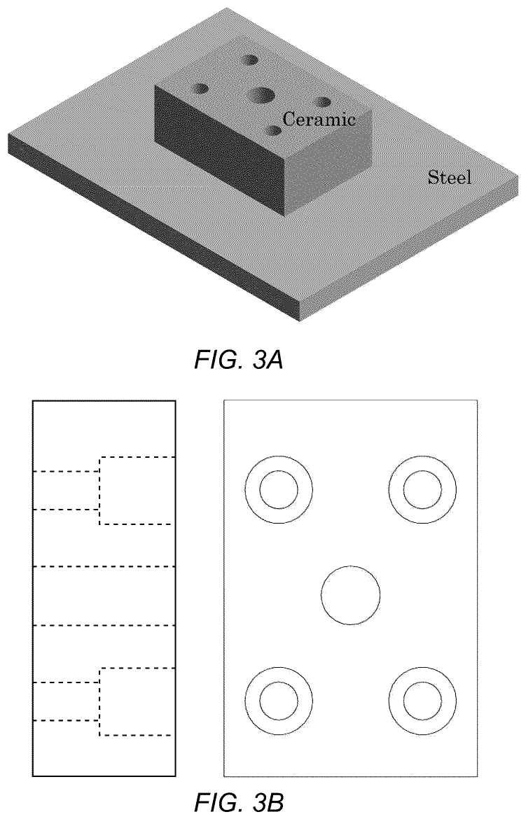

Transient thermal simulations were performed to determine the optimal geometry of the insulator block in the gripper's finger assembly. Simulations were carried out in the finite element modeling software, ANSYS Workbench. The thermal setup used, shown in FIG. 3A, consisted of a steel test plate and the ceramic insulator. The insulator was modeled as a ceramic and the test plate was modeled as 4140 alloy steel. The plate was modeled with dimensions 100×75×6 mm. The insulator was modelled as 44×30 mm and variable thickness, with clearance holes and counterbores for 4 mm shoulder bolts as well as clearance holes for a 7 mm thermocouple. FIG. 3B shows multiple views of the insulator. The insulator was placed on top of the steel plate. The plate was set to an initial temperature of 1000° C., and the insulator was set to an initial temperature of 22° C. The contact between the two was selected to be frictional. Convection was modelled as free air, with a heat transfer coefficient of 5 W/m²K. The convection temperature was selected by modelling the ambient temperature of a furnace. The furnace was heated to 1000° C., opened, and the ambient air temperature inside of the furnace after 1 minute was measured as 600° C. The convection temperature was modelled after this trend and was assumed to occur linearly across the entire simulation period. The simulation was run for a time period of 60 s, with step sizes of 1 s.

TABLE 1
Casted ceramic and 4140 alloy steel material properties

| | Thermal | Coefficient of |
|---|---|---|
| | Conductivity k | Thermal Expansion |
| | [W/mK] | α [μm/m-° C.] |
| Casted Ceramic | 1.44 | 7.2 |
| (Cotronics) | | |
| Low alloy steel, 4140, | 43.33 | 12.2 |
| normalized | | |

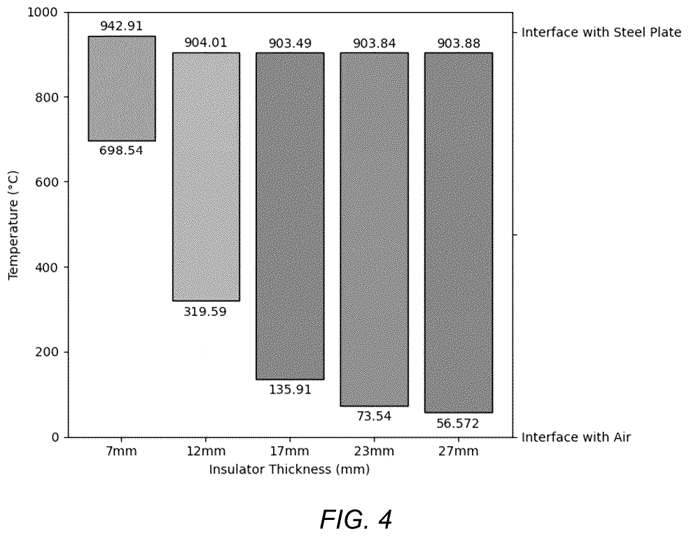

The relevant material properties are included above in Table 1. For the insulator, the thermal conductivity and coefficient of thermal expansion were provided by the manufacturer, Cotronics. To determine the ideal thickness of the insulator, five separate simulations were performed. Thicknesses of 7, 12, 17, 22, and 27 mm were examined. Each of these simulations were performed under the same conditions, as detailed above, only varying the thickness between each simulation. The maximum and minimum temperatures from each simulation were recorded and imported into a Python script. FIG. 4 shows the temperature difference for each thickness of insulator.

The governing equation for three-dimensional transient thermal analysis is shown below in Equation 1, where k is thermal conductivity and q is heat generation. Equation 2 is Newton's Law of Cooling, describing the heat transfer due to convection, where q is the heat rate and h is the convective heat transfer coefficient. Utilizing the heat generation due to convection in addition to the heat equation allows for an examination of both the conductive and convective effects.

$$\frac{\partial }{\partial x} ( k \frac{\partial }{\partial x} ) + \frac{\partial }{\partial y} ( k \frac{\partial }{\partial y} ) + \frac{\partial }{\partial z} ( k \frac{\partial }{\partial z} ) + \dot{q} = ρ {c}_{p} \frac{\partial T}{\partial t} \qquad ( 1 )$$

$$q = hA ( {T}_{s} - {T}_{∞} ) \qquad ( 2 )$$

FIG. 4 is a bar chart containing the temperature differences for each simulation. With the five sample thicknesses evaluated, there is a distinct negative correlation between the insulator thickness and the minimum temperature. The thinnest insulator, 7 mm, had a maximum temperature of 942.91° C. and a minimum temperature of 698.54° C., while the thickest insulator, 27 mm, had a maximum temperature of 903.88° C. and a minimum temperature of 56.57° C. The correlation appears to have diminishing returns, with the increase in thickness decreasing the minimum temperature less. This is confirmed by examining the insulator efficiency, which is the reduction of temperature each millimeter of insulator thickness has for each simulation. These values, along with the minimum and maximum temperature, are shown in Table 2. The lowest insulator efficiency is at the 27 mm, with a temperature reduction of 31.38° C./mm. The highest insulator efficiency occurs at 12 mm, with a temperature reduction of 45.15° C./mm. Excluding the 7 mm simulation, the maximum temperature was just around 904° C., despite the varying minimum temperatures.

TABLE 2
Thermal simulation results and insulator efficiency

| | Thermal 1 | Thermal 2 | Thermal 3 | Thermal 4 | Thermal 5 |
|---|---|---|---|---|---|
| Thickness | 7 | 12 | 17 | 22 | 27 |
| [mm] | | | | | |
| Min. Temp | 698.54 | 319.59 | 135.91 | 73.54 | 56.57 |
| [° C.] | | | | | |
| Max. Temp | 942.91 | 904.01 | 903.49 | 903.84 | 903.88 |
| [° C.] | | | | | |
| Insulator Eff. | 34.91 | 48.70 | 45.15 | 37.74 | 31.38 |
| [° C./mm] | | | | | |

The manufacturer specified maximum temperature for the casted ceramic was 1650° C., far above both the simulation temperatures as well as the expected maximum temperature of the laser bed powder fusion (LBPF) machine. For all of these simulations, the ceramic itself is able to handle the temperature that it is being exposed to.

Purely from a temperature reduction standpoint, the 27 mm thickness performed best. However, thermal efficiency per unit of additional thickness fell with increasing thickness. The performance difference between the 22 mm and the 27 mm thickness samples was small in terms of the final temperature despite ˜25% difference in ceramic material thickness. This may be attributed to the limiting factor of heat transfer, as evidenced by equal maximum temperatures. The difference in efficiency may be expected to become larger if the insulator face was larger or the temperature was significantly higher. The second consideration is the temperature itself of the contact. The finger is constructed of 4140 alloy steel, a very hard, very strong alloy. Although direct contact would destroy the surface microstructure and optimum mechanical properties obtained by the heat treatment of the steel, even the lowest thickness insulator should protect it. However, the steel serves as a conductor that connects to the body of the 2F-140 gripper, which itself has a maximum temperature rating of 50° C. There is a lot of mass between the insulator and the gripper body, but temperatures in excess of 200° C. would likely damage the end effector. Considering this as well as the insulator efficiency, the 17 mm thickness was selected for this Example. The 17 mm had a similar efficiency to the 12 mm, but has a much lower minimum temperature, at 135.91° C. The 17 mm was an ideal choice for another reason as well—the manufacturing. Insulators in excess of 20 mm resulted in a very large finger, as it has to offset the insulator. This not only makes the billet significantly more expensive, but also increases machining time, both of which are desirably avoided if possible. Finally, the thickness of insulator is thick enough to easily switch out the insulator shape to accommodate different shapes, if desired.

### Ceramic Casting Method

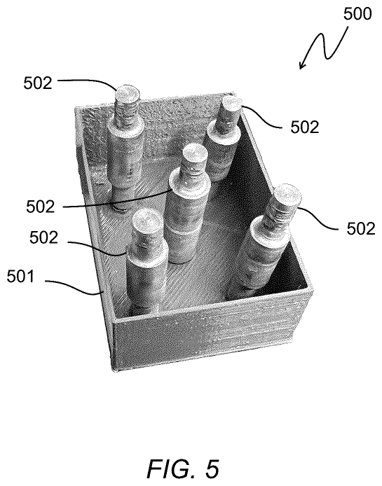

FIG. 5 depicts a mold 500 for making a ceramic insulator block. A casing 501 of the mold for the aluminum oxide ceramic was created on a fused deposition modeling (FDM) 3D-printer out of polyethylene terephthalate glycol (PETG). The casing was designed larger relative to the desired dimensions by approximately 2% to account for shrinkage. The inside of the casing 501 and the machined casting pins 502 were sprayed with a mold-release spray. The five casting pins 502 were inserted into the holes at the bottom of the casing arranged as pictured in FIG. 5. The pins were not used when casting a test sample for materials testing.

A second coat of the mold-release spray was sprayed onto both the pins 502 and the inside of the casing 501. A 100:25 ratio of aluminum-oxide powder and the activator was measured by weight. They were mixed until a thick, paste-like consistency was reached. The mixture was scraped into the prepared casing, overfilling slightly. A 3D-printed jig was used on the top and bottom of the pins to align pin orientation. The ceramic was slightly set after 20 minutes, and any extraneous material was scraped off of the top. The ceramic was left to cure at room temperature (˜22° C.) for 16-24 hours. The ceramic was removed from the casing using a sharp blade. For the first post-cure, the ceramic was placed into a furnace at 110° C. for 2.5 hours. The pins were then removed from the ceramic using a pair of locking pliers. For the second post-cure, the ceramic was placed into a furnace at 1000° C. for 2 hours, restricting the temperature rate to a maximum of 100° C./hour.

### Compression Strength and 3-Point Bending Test

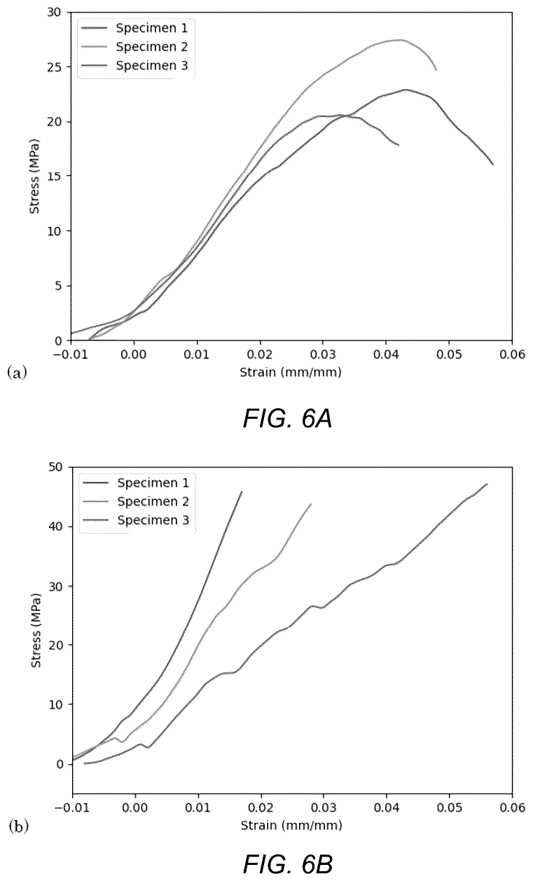

Six rectangular test samples were created using the ceramic casting method described above, with approximate dimensions of 45×30×17 mm. Three samples were partially heat-treated, retained after only the first post-cure. The remaining three were fully heat-treated. Calipers were used to measure the dimensions of the sample. One sample was loaded into an MTS® Insight 30 equipped with a 3 kN force sensor, using jaws for compression testing. For the 3-point bending test, the jaws were replaced with the 3-point bending testing chuck. The MTS® testing software was used to zero the force sensors and the measured dimensions were input. The desired experimental test was executed until failure. The software produced a table with time, load, extension, stress, and strain values. The output was saved as a .txt file. This process was repeated with remaining samples. All collected data was then imported into a Python script. For each sample, the load and stress values were averaged at every unique strain value, and an interpolated spline function was applied to smooth the data. FIGS. 6A and 6B show the stress-strain curves for the partially and fully heat-treated samples that were produced, with one line for each sample.

The stress-strain curves produced from the compression test method are shown in FIGS. 6A and 6B for the partially heat-treated and fully heat-treated samples, respectively. The maximum stress and load values for each sample are included below in Table 3. The fully heat-treated samples had an average ultimate stress of 45.47 MPa and the unfired samples had an average ultimate stress of 23.61 MPa. The percent difference of ultimate stress between the partially and fully heat-treated samples is 63.30%. The compressive strength provided is 41.37 MPa, leading to a percent difference between the given and experimental value of 9.45%, with the experimental higher than the provided value from the raw material manufacturer, Cotronics.

For the compression strength testing, the fully heat-treated samples are nearly twice as strong in compression when compared to the partially heat-treated samples. The failure mode is significantly more brittle after the firing process; the partially heat-treated samples were still able to retain structure in the testing process before being fractured, but the fully heat-treated samples were shattered once ultimate stress was reached. The fully heat-treated samples are exponentially stronger when compared to the partially heat-treated samples—the partially heat-treated samples crumbled quite easily during general handling and transport, but the fully heat-treated samples can survive falls from a minimum height of one meter, losing only some small fragments and dust. The results of the materials testing fare very well against the provided specifications for compressive strength, exceeding the specifications detailed by the raw material manufacturer.

TABLE 3
Stress and load values from compression testing

| | Speci- | Speci- | Speci- | Speci- | Speci- | Speci- |
|---|---|---|---|---|---|---|
| | men 1, | men 2, | men 3, | men 1, | men 2, | men 3, |
| | Unfired | Unfired | Unfired | Fired | Fired | Fired |
| Ultimate Stress | 22.863 | 27.394 | 20.569 | 45.722 | 43.670 | 47.027 |
| σₘₐₓ [MPa] | | | | | | |
| Maximum | 11.923 | 22.863 | 11.020 | 21.600 | 21.606 | 21.823 |
| Load F [kN] | | | | | | |

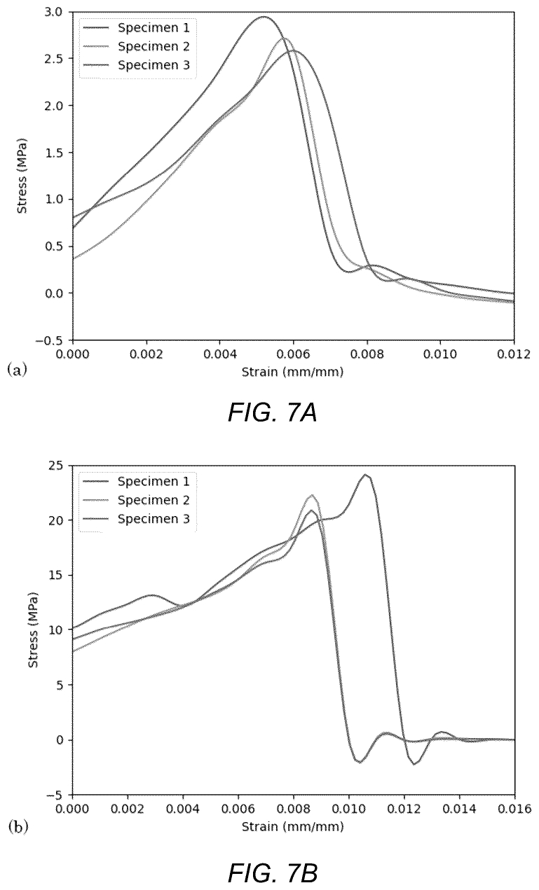

The stress-strain curves produced from the 3-point bending test method are shown in FIGS. 7A and 7B for the partially and fully heat-treated samples, respectively. The maximum stress and load values for each sample are included below in Table 4. In Table 4 “spec.” is short for “specimen,” and “part.” is short for “partial”. The average ultimate stress for the fully heat-treated samples was 20.50 MPa and the average ultimate stress for the partially heat-treated samples was 2.70 MPa. The percent difference of the ultimate stress between the partially and fully heat-treated samples is 153.43%. Material specification for modulus of rupture included ranges for cures at room temperature (5.52-8.27 MPa), 535° C. (6.89-13.79 MPa), 910° C. (10.34-20.68 MPa), and 1350° C. (20.68-48.26 MPa). Assuming that the values vary linearly, interpolating the modulus of rupture for a cure of 1000° C. should be approximately 24.13 MPa, leading to a percent difference between the given and experimental value of 16.27%, with the experimental value lower than the value provided by the manufacturer of the raw material.

Similar comparisons to the failure mode of the compression strength testing can be seen for the three-point bending testing, with a more ductile failure from the partially heat-treated samples and a more brittle failure from the fully heat-treated samples. The experimental samples are lower than the provided values, although it is important to note that only a range was provided for the strength, not a specific value. The range for all of the cure temperatures are very wide and given the conditions for casting did not include casting under a vacuum or properly vibrating the mold, this value makes sense.

TABLE 4
Stress and load values from 3-point bending testing

| | Spec. | Spec. | Spec. | Spec. | Spec. | Spec. |
|---|---|---|---|---|---|---|
| | 1, Part. | 2, Part. | 3, Part. | 1, Full | 2, Full | 3, Full |
| | HT | HT | HT | HT | HT | HT |
| Ultimate Stress | 2.915 | 2.611 | 2.579 | 21.910 | 20.452 | 19.142 |
| σₘₐₓ [MPa] | | | | | | |
| Max. Load F | 0.344 | 0.303 | 0.261 | 2.099 | 2.213 | 1.927 |
| [kN] | | | | | | |

### Thermal Conductivity Test

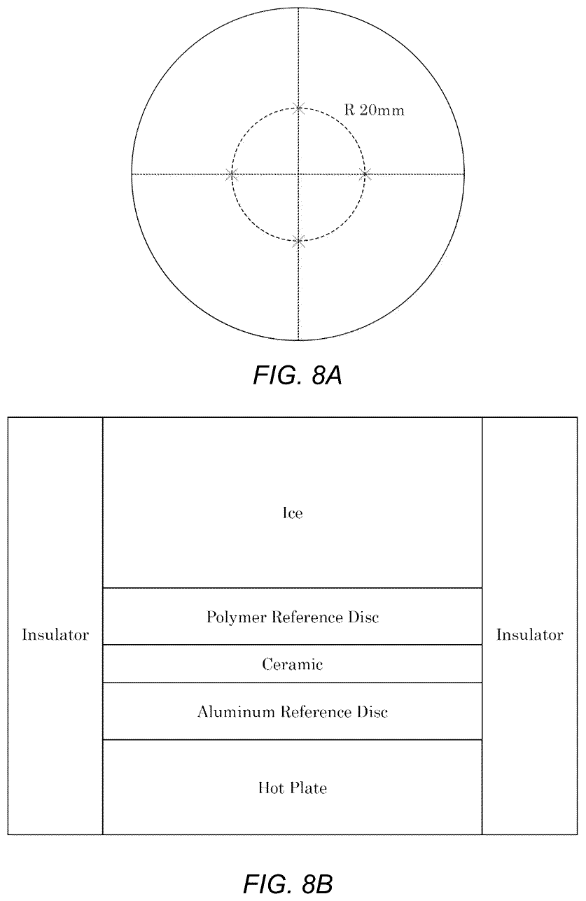

A cylindrical test sample was created using the ceramic casting method described above, with approximate dimensions of 106.5 mm diameter×4 mm thickness. Two perpendicular centerlines and a 20 mm radius circle were marked on both faces. Thermocouples were placed and secured on each intersection, noted by the X's in FIG. 8A between the centerlines and the circle, for a total of 8 thermocouples. The location of each thermocouple was recorded. As shown in FIG. 8B, the following were stacked on a hot plate: aluminum reference disc, ceramic test sample, and polymer reference disc. Prior to placing the polymer onto the hot plate, the height was measured using calipers. An insulating foam sleeve was placed over the stack, followed by a beaker filled with de-ionized ice.

The hot plate was turned on and set to 1000° C. Once steady state temperatures were reached, with the ice replaced as necessary, readings were recorded for 60 seconds using a NI-9213 Temperature Input Module in a National Instruments DAQ connected to Lab VIEW. The results were saved in a .csv file. The data was compiled into an Excel spreadsheet, where the readings from the thermocouples in contact with the aluminum were averaged to determine a TH and the thermocouples in contact with the polymer were averaged to determine a Tc.

For one-dimensional steady-state heat conduction, Fourier's Law, shown in Equation 3, can be used to calculate the experimental thermal conductivity of the ceramic using the known thickness, temperature, and heat transfer coefficient for the polymer disc.

$${ϕ}_{q} = - k \frac{dT ( x )}{dx} \qquad ( 3 )$$

$${k}_{ceramic} = {k}_{polymer} \frac{Δ {T}_{polymer} Δ {x}_{ceramic}}{Δ {T}_{ceramic} Δ {x}_{polymer}} \qquad ( 4 )$$

Using Equation 3 to equate the heat flux through the polymer to the heat flux through the ceramic results in Equation 4. This was used to determine an experimental thermal conductivity for the ceramic.

Across the three tested samples, the average thermal conductivity was 5.123 W/mK with a sample standard deviation of 1.22. The thermal conductivity provided was 1.44 W/mK, leading to a percent difference between the given and experimental value of 112.17%.

TABLE 5
Thermal conductivity results

| | Specimen 1 | Specimen 2 | Specimen 3 | Average |
|---|---|---|---|---|
| Experimental | 5.791 | 3.713 | 5.864 | 5.123 |
| Thermal | | | | |
| Conductivity k | | | | |
| [W/mK] | | | | |

There are several possible reasons the experimental value is higher than the given value, by a fair margin. The test method is adapted from a procedure described by Aaron Christopher Whaley at the University of Tennessee. This procedure detailed a configuration in which the cold temperature is applied from the bottom, and the order of layered materials is as follows, from bottom to top: aluminum, stainless steel sheet, silicon carbide, reference 1, test sample, reference 2, and silicon carbide once again. Additionally, there were guard heaters on the sides as well as the top to constrict conductive heat flow from the top to the bottom. There were also several thermocouples to measure the temperature at every interface. This procedure was used with samples of thickness greater than 16 mm. The adapted test bed differed from the described configuration and could possibly contribute to the measured thermal conductivity. The orientation of the test bed is opposite of the described configuration, and as such, allows for potential heat convection to travel upwards, bypassing the intended conduction. The sample is also significantly thinner than the ones tested by Whaley, which could explain a much lower temperature difference seen at either surface of the test sample. Additionally, the cold interface is applied less efficiently than the described cooler, requiring heat transfer to take place through glass whereas the hot interface is applied directly. Despite the possible sources of error, the experimental thermal conductivity is low enough to be effective and protect the end effector from the high temperatures.

### Thermal Shock Test

Three insulators were created as detailed in the ceramic casting method above, fully heat treated. A plate of steel was placed into a furnace and heated to 1000° C. The internal temperature of the furnace was allowed to reach steady state. The furnace was turned off without opening the door. The insulator was picked up with tongs, the furnace door was opened, and the insulator was placed on the surface of the steel. Any visual changes in the insulator, including deformation, cracks, and discoloration were recorded, and observations were repeated at: 2 min, 5 min, 10 min, 30 min, 1 hour, and when the ceramic was cool to the touch (˜10 hours). This was repeated for all three samples.

Table 7 shows any changes observed among the three samples. For all three samples, the test resulted in no more than a slight char in one sample.

TABLE 7
Thermal shock test results

| | Specimen 1 | Specimen 2 | Specimen 3 |
|---|---|---|---|
| Initial contact | No change | No change | No change |
| 2 minutes | No change | No change | No change |
| 5 minutes | No change | No change | No change |
| 10 minutes | No change | No change | No change |
| 30 minutes | No change | No change | No change |
| 1 hour | No change | No change | No change |
| Once cool | No change | Slight brown | No change |
| | | char on one edge | |

The thermal shock test demonstrated the strength of the casted material and the resistance it has to thermal shock. From an external and qualitative view, none of the samples were damaged. The brown char on specimen 2 was due to misplacement, which caused uneven loading, noticed only after the test had been finalized.

### Computed Tomography (CT) Scan

Three cylindrical ceramic samples were casted using the ceramic casting method described above, with mold dimensions of 10 mm diameter and 5 mm thickness. One sample was partially heat-treated, retained after only the 100° C. post-cure. The second sample was fully heat-treated. The third sample was fully-heat treated and additionally underwent the high temperature furnace test. CT scans of all three samples were obtained using a Bruker Skyscan 1173. The image processing was performed in Fiji ImageJ with the 3D viewer plugin. The pores in these images were filtered using an Otsu binary threshold and stray pixels were removed using a radius median filter. The same filter was applied to all three image sets. The area of each pore not continuous with the background was calculated and summed to determine total porosity area, and this was multiplied by the scale of 7.9 μm/pixel to determine a total porosity volume.

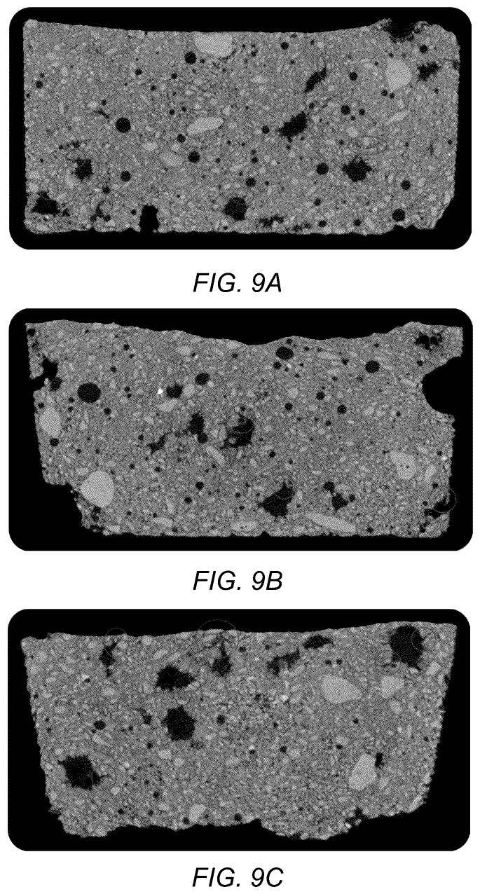

The goals of the CT scans were twofold in nature: to examine the porosity across the ceramic at different stages of the casting process and to determine if evidence of microcracking exists at a higher percentage in the tested sample when compared to the fully heat-treated sample. FIGS. 9A, 9B, and 9C are images from the CT scan that display some amount of cracking, identified with circle annotations superimposed on the CT images.

The main feature of interest was the presence of microcracks within the samples. Specifically, the ratio of cracks found within the fully heat-treated sample to the cracks found within the tested sample. As demonstrated by the thermal shock test, the tested samples showed no external signs of damage. However, this doesn't mean that the tested samples had no internal damage due to the thermal stress, in the form of microcracks. It was assumed that if approximately equal densities of microcracks were observed in both the fully heat-treated and tested samples, then the testing had little effect on the longevity of the insulator. The fully heat-treated and tested samples went through the same fabrication and heat treatment at the same time, so they were exposed to equal conditions. Any significant difference should only be attributed to the additional step of testing. For insight at thermal stress at all stages of thermal exposure, a partially heat-treated sample was included as well. The determination of cracks was performed manually. The cracking is primarily seen at and around the edges of the pores. There are approximately equal amounts of cracks between all three images, but the cracks seen in the tested sample appear to have propagated very slightly. This would indicate that even though immediate failure was not observed, there was some level of damage to the ceramic. However, since the cracks are mostly associated with pores as a result of the casting process, it is possible that with improved casting conditions that the effects of the thermal loading would decrease and should retain strength better.

TABLE 6
Computed tomography scan porosity results

| | Partial HT | Full HT | Tested |
|---|---|---|---|
| Porosity Volume, mm³ | 22.51 | 29.30 | 21.29 |
| Total Volume, mm³ | 379.43 | 379.01 | 365.50 |
| Percent Shrinkage, % | 3.33 | 3.44 | 6.88 |
| Percent Porosity, % | 5.93 | 7.73 | 5.86 |

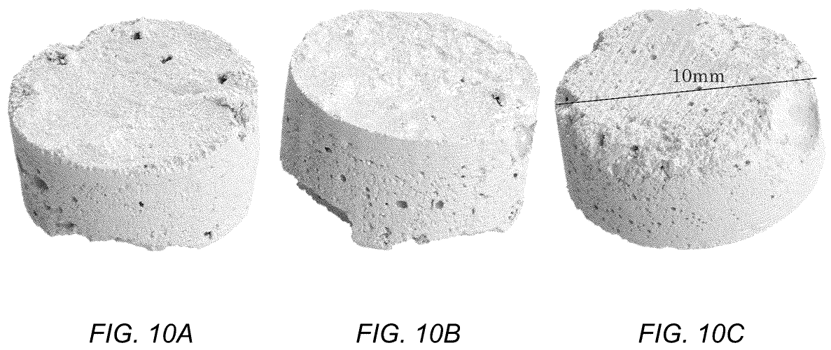

The nominal volume of each sample is 392.5 mm³. The porosity volume, the total volume, the percent shrinkage (when compared to nominal volume), and the percent porosity for all three samples are shown in Table 6. The porosity volume was highest in the fully heat-treated sample and lowest in the tested sample, with values of 29.30 mm³ and 21.29 mm³, respectively. The only notable total volume was the tested sample, with a value of 365.50 mm³, which led to an elevated shrinkage of 6.88%. The percent porosity across all three samples was around the same, with the fully heat-treated sample having a value of 7.73% and the tested sample having a value of 5.86%. Across all three samples, there was no noticeable trend regarding porosity. Of all three, the fully heat-treated sample had the highest percentage of porosity, which would indicate that the porosity is indicative of the casting process rather than the heat treatment or testing process. This is affirmed by examining the porosity of the partially heat-treated and tested samples, which despite having gone through different levels of heat treatment and testing have very similar porosities. More than likely, the higher porosity is due to different settling of the casting material, as the molds were not vibrated. This is visually supported by the renders seen in FIGS. 10A, 10B, and 10C as there are differing amounts of external facing pores. The poor cast quality could potentially be attributed due to the size of the samples; the samples were significantly thinner than any of the other insulators or test pieces created.

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described.

As used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only”, and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of events recited or in any other order which is logically possible.

While exemplary embodiments of the present invention have been disclosed herein, one skilled in the art will recognize that various changes and modifications may be made without departing from the scope of the invention as defined by the following claims.

What is claimed is:

1. A robotic end effector finger assembly, comprising
a ceramic insulator; and
an alloy finger backing the ceramic insulator,
wherein the end effector has a maximum operation temperature of at least 400° C.

2. The robotic end effector finger assembly of claim 1, wherein the ceramic insulator is configured as an external object interface.

3. The robotic end effector finger assembly of claim 1, further comprising fasteners, wherein the ceramic insulator has through holes which accommodate the fasteners, wherein the fasteners fasten the ceramic insulator to the alloy finger.

4. The robotic end effector finger assembly of claim 3, wherein the fasteners are shoulder bolts.

5. The robotic end effector finger assembly of claim 1, wherein the ceramic insulator is a cast ceramic.

6. The robotic end effector finger assembly of claim 1, wherein the ceramic insulator is an aluminum oxide ceramic.

7. The robotic end effector finger assembly of claim 1, further comprising a mount for a temperature measurement device.

8. The robotic end effector finger assembly of claim 7, wherein the temperature measurement device is a thermocouple.

9. The robotic end effector finger assembly of claim 7, wherein the ceramic insulator has a through hole configured to accommodate the temperature measurement device.

10. The robotic end effector finger assembly of claim 1, wherein the maximum operation temperature is at least 1000° C.

11. The robotic end effector finger assembly of claim 1, wherein the maximum operation temperature is upwards of 2000° C.

12. The robotic end effector finger assembly of claim 1, further comprising an adapter configured for connecting the alloy finger to a body of an end effector.

13. The robotic end effector finger assembly of claim 1, wherein the alloy finger comprises an offset that accommodates a thickness of the ceramic insulator.

14. A robotic gripper, comprising
two or more digits moveable with respect to one another, wherein at least one of the two or more digits comprises
a ceramic insulator, and
an alloy finger backing the ceramic insulator,
wherein the robotic gripper has a maximum operation temperature of at least 400° C.

15. The robotic gripper of claim 14, wherein the robotic gripper is an adaptive gripper capable of a variable size gripping stroke with the two or more digits.

16. The robotic gripper of claim 14, wherein the ceramic insulator is configured as an external object interface.

17. The robotic gripper of claim 14, wherein the ceramic insulator is a cast ceramic.

18. The robotic gripper of claim 14, wherein the alloy finger comprises an offset that accommodates a thickness of the ceramic insulator.

19. A method of producing a metal part, comprising
producing an incomplete metal part by a first additive manufacturing process;
manipulating the incomplete metal part with a robotic gripper, the robotic gripper comprising two or more digits moveable with respect to one another, wherein at least one of the two or more digits comprises a ceramic insulator and an alloy finger backing the ceramic insulator, wherein the end effector has a maximum operation temperature of at least 400° C.; and
performing a second manufacturing process after the manipulating step.

20. The method of claim 19, wherein the first and second additive manufacturing processes are laser bed powder fusion (LBPF) processes.

21. The method of claim 19, further comprising
sensing a temperature of the incomplete metal part using one or more temperature measurement devices, and
making one or more decisions which affect the manipulating step based on the sensed temperature.

22. The method of claim 19, wherein the second manufacturing process is a second additive manufacturing process.
